(19) United States
(12) Patent Application Publication
(10) Pub. No.: US 2010/0238670 A1
(43) Pub. Date: Sep. 23, 2010

(54) Recessed ceiling fixture enclosure

(76) Inventor: John P. Moench, St. Louis, MO (US)

Correspondence Address: Paul M. Denk, Suite 305, 763 S. New Ballas Road, St. Louis, MO, 63141, US

(21) Appl. No.: 12/800,901

(22) Filed: May 25, 2010

Related U.S. Application Data
(63) Continuation of application No. 11/788,533, filed on Apr. 20, 2007.
(60) Provisional application No. 60/797,311, filed on May 3, 2006.

(51) Int. Cl. F21V 15/01; H02G 3/30; E04B 1/94; E04B 1/38

(52) U.S. Cl. 362/365; 52/29; 52/741.3; 52/745.2

(57) ABSTRACT

An enclosure for use in conjunction with a recessed ceiling fixture is provided which includes a substantially rectangular housing defining a top wall and side walls constructed from a single piece of fire-resistant gypsum wallboard. The housing is fastened to continuous stamped metal support flange depend inwardly from bottom edges of side walls of the housing to facilitate mounting of the housing between spaced apart building joists. The recessed fixture is mounted to the interior of the support flange after installation of the housing between the building joists.

### CROSSREFERENCE

This continuation patent application claims priority to the regular letters patent application having Ser. No. 11/788,533, which was filed on April 20, 2007; which claims priority to the provisional patent application having Ser. No. 60/797,311, which was filed on May 3, 2006.

### FIELD OF INVENTION

The current invention relates to an apparatus for preventing the spread of heat, fire and hot gases in buildings that require a fire rate separation between floors of a building.

### BACKGROUND OF THE INVENTION

In residential, commercial, apartment, condominium and assisted living buildings it is commonplace to install recessed fixtures such as lighting fixtures, loudspeakers and security cameras in ceilings where a portion of these devices extend through the ceiling and into the cavity between the floor joists of the adjacent floor and or roof structure. A typical multi-family residential condominium building can have several hundred recessed devices of these types.

In the building trade it is well know that a creating an opening in the ceiling plane to accommodate a recessed device the fire-rated barrier is compromised. The subject invention surrounds the light fixture with a fire-resistant material and provides protection that restores the fire-rated barrier between the floors. The fire-ratings are determined by the local governing building code and enforced by building code officials.

The 2003 International Building Code (IBC) states in Section 711.3 that “the fire-resistance rating of floor and roof assemblies shall not be less than that required by the building type of construction. Floor assemblies separating dwelling units in the same building or sleeping units in occupancies in Group R-1, hotel occupancies, R-2 and I-1 shall be of 1-hour-fire-resistance-rated construction.”

The Uniform Building Code (U.B.C.) requires that openings or penetrations for recessed lighting fixtures in all wood framed ceiling assemblies must be protected by a penetration firestop system. Such a system must limit the spread of fire, flame or hot gases through the firestop assembly for an acceptable period of time, when tested in accordance with the time-temperature curve provided in U.B.C. Standard 7-1, which is herein incorporated by reference.

It is known in the construction industry that building a gypsum wallboard enclosure around a recessed fixture to isolate it from the surrounding structure is an accepted means of providing the required fire-resistance-rated construction. A site-fabricated enclosure is typically constructed by cutting gypsum wallboard into individual pieces. These pieces are mechanically fastened to the adjacent boards forming a five-sided box. Two layers of wallboard are often required to give the box structural stability resulting in longer construction time and the additional expense of materials. Paper joint tape and joint compound are applied to the interior and exterior corners of the enclosure to close the open joints between the adjacent sides of the box. The finished enclosure must then dry over a 24-hour period prior to installation. Multiple building trades are involved in the process as well: drywall contractors to install the boxes and electrical contractors to install the light fixtures.

The assembly and finishing processes are time consuming and very inefficient when performed in the field. As a result of the inefficiencies of the process, the finished product is higher in price and lower in quality than an enclosure produced off-site in a regulated environment.

An example of a fire resistant barrier constructed with fire-resistant materials is disclosed in U.S. Pat. No. 6,105,334, to Monson. The system designed employs a stamped sheet metal box which is coated with an intumescent fire resistant material in the inside and or outside of the enclosure. This device is reliant upon the fire resistant capabilities of the intumescent barrier to provide fire protection and is dependant upon the five sided metal housing unto which the fire resistant material is applied. There remains a need in the art for an inexpensive alternative to the construction characteristics of the fire stopping system.

### SUMMARY OF THE INVENTION

The subject of the invention is a pre-fabricated fire resistant enclosure for recessed fixtures employed in residential and commercial buildings which conforms to applicable building codes relating to floor/ceiling penetrations. In that which follows, the fire resistant enclosure of the subject invention is detailed and illustrated in conjunction with a recessed lighting fixture. It should be noted that the subject invention is suitable for use with other recessed fixtures, such as, for example, loudspeaker or recessed video camera devices.

The subject invention is an enclosure formed from a single ⅝″ thick standard sheet of fire resistant gypsum wallboard. This material is widely produced and readily available.

The enclosure is defined by a top wall and four side walls that are attached to each other via a living hinge created when a CNC router mills away the front paper face of the gypsum wallboard and the interior fire-resistant gypsum core leaving the back paper intact face to act as said hinge.

The top and side walls have an inherent fire resistant characteristic that does not require the introduction of any additional fire resistant materials to further enhance the fire resistant characteristics of the gypsum wallboard enclosure.

The top and side walls are folded and mechanically fastened together to provide a mitered inside corner of the adjacent sides.

The enclosure is mechanically fastened to a support flange depend outwardly for mounting the enclosure between the spaced apart building joists. The bottom of the flange is designed to facilitate mounting the enclosure to the adjacent joist structure at 16.0 inch on center. These dimensions can be modified to accommodate other joist spacing, such as, for example, 12.0 inch and 24.0 inch on the center.

The second and forth side walls are designed to provide an aperture to accommodate the passage through the side wall of electrical wire and or electrical conduit required to service the light fixture with the necessary electrical power to operate properly.

The subject invention is wrapped with a continuous tape with an inwardly facing pressure-sensitive adhesive coating which applies pressure to the open joints and forms a corner of continuous gypsum wallboard material forming a tighter seal at the open joints of the enclosure when applied. This material is widely produced and readily available.

The subject invention also includes a method of installing recessed ceiling fixtures. This method includes the steps of providing an enclosure configured to enclose a fixture and provide both the interior and exterior surfaces of the housing with a fire resistant material and mounting the housing in the cavity above the ceiling created by the floor joists of the floor above.

The method further includes the steps of emplacing a fixture within the housing, passing electrical wires through an aperture formed in at least one side wall of the housing, and sealing the aperture after passing the electrical wires there through. The method also includes the step of positioning the enclosure in a first orientation for mounting between building joists spaced at 16.0 centers.

### BRIEF DESCRIPTION OF THE DRAWINGS

In referring to the drawings;

FIG. 1 is an axonometric view of one embodiment of an assembly of the present invention.

FIG. 2 is an axonometric view of the gypsum wallboard as it appears after it is milled by a CNC router prior to folding into a rectangular enclosure.

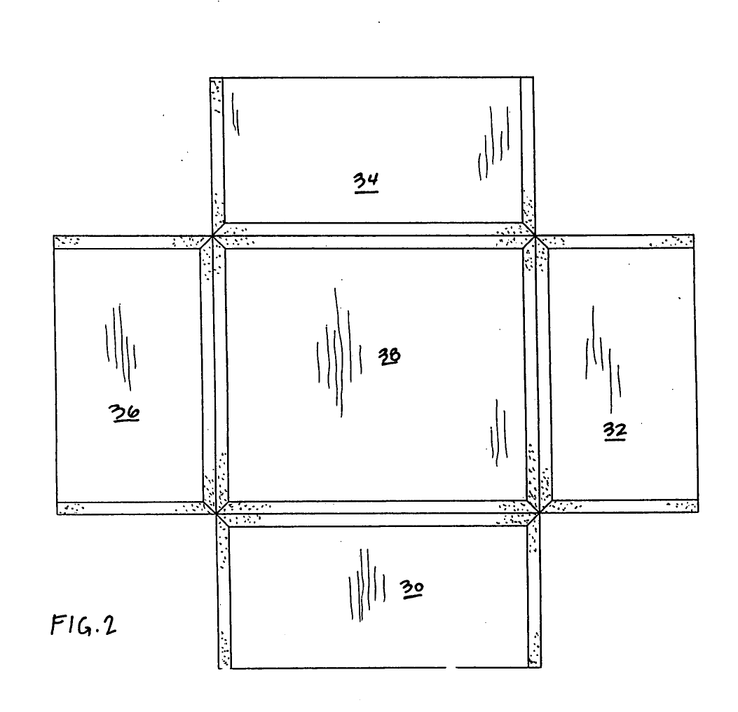

FIG. 3 is an axonometric view of the gypsum wallboard as it appears partially folded to form the five-sided enclosure.

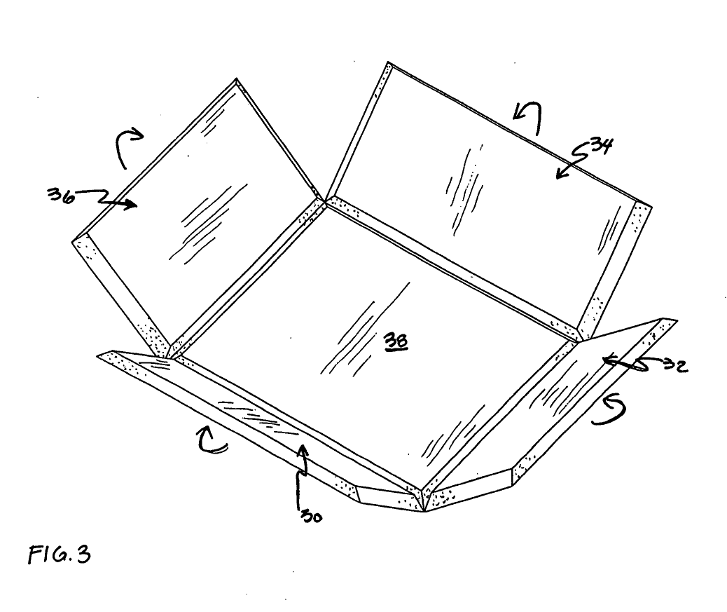

FIG. 4 is an axonometric view of the stamped sheet metal flange onto which the enclosure is fastened.

FIG. 5 is a cross-sectional view through the enclosure in accordance with a preferred embodiment showing the orientation of the light fixture within the enclosure mounted between building joists spaced at 16.0 inch centers.

FIG. 6 is a cross-sectional view through the enclosure in accordance with a preferred embodiment showing the orientation of the light fixture within the enclosure mounted between building joists spaced at 24.0 inch centers.

### DESCRIPTION OF THE PREFERRED EMBODIMENT

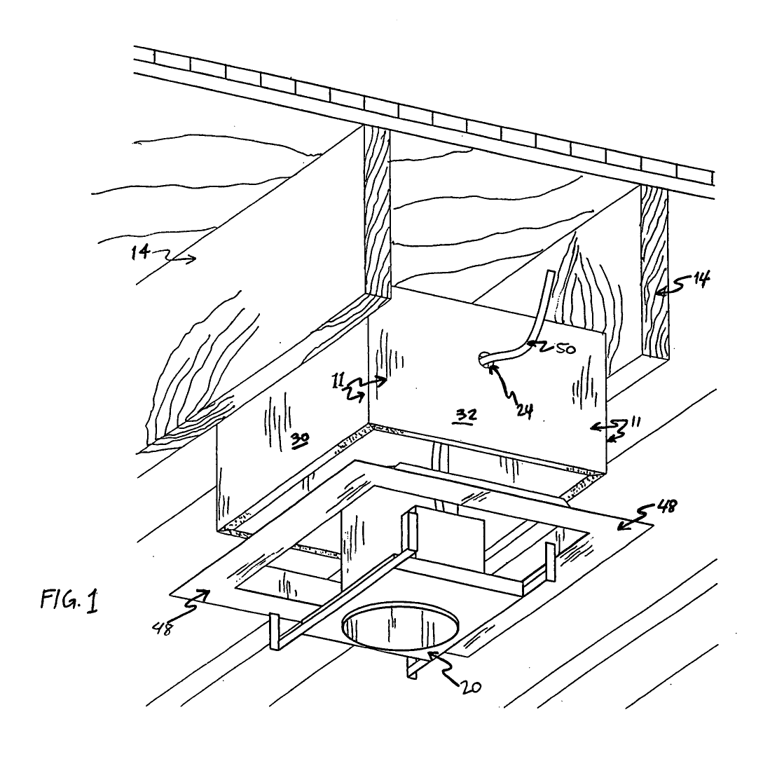

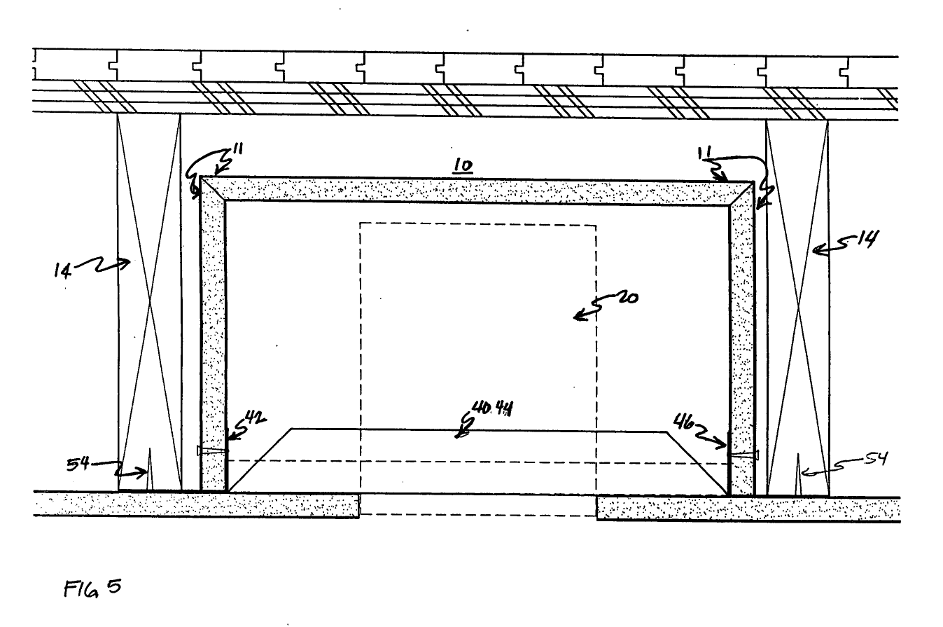

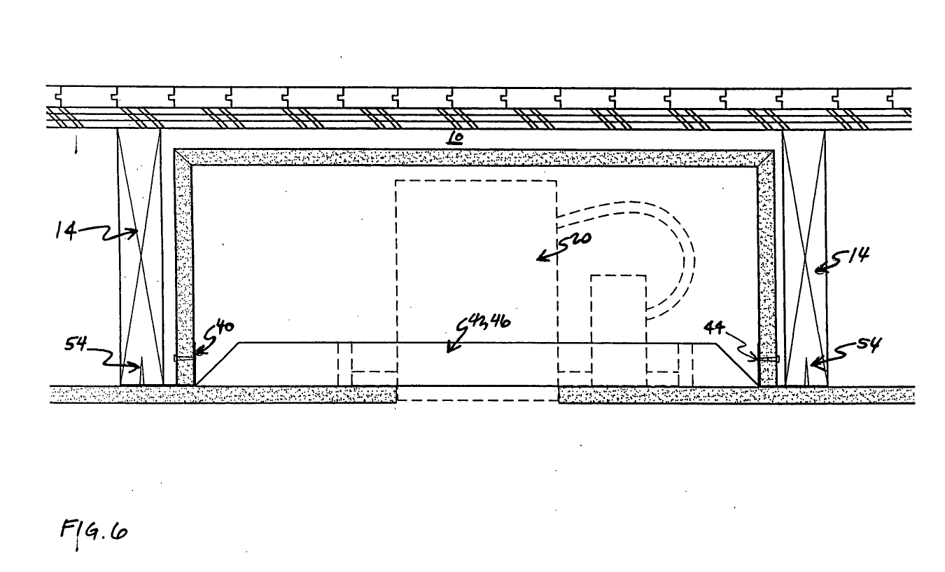

Referring now in detail to the drawings wherein like reference numerals identify similar structural elements of the subject invention, there is illustrated in FIG. 1 a fire rated lighting enclosure constructed in accordance with a preferred embodiment of the subject invention and designated generally by reference numeral 10. Lighting enclosure 10 has a generally rectangular box-like configuration and is configured to enclose a conventional recessed lighting fixture 20 when installed between adjacent 14 ceiling joists, as shown for example in FIGS. 5 and 6. Once installed, the fire rated lighting enclosure 10 of the subject invention provides a durable structure which isolates a heat generating recessed lighting fixture 20 from combustible material adjacent thereto, and prohibits the propagation of fire through the ceiling penetration associated with the lighting fixture in conformance with applicable building codes.

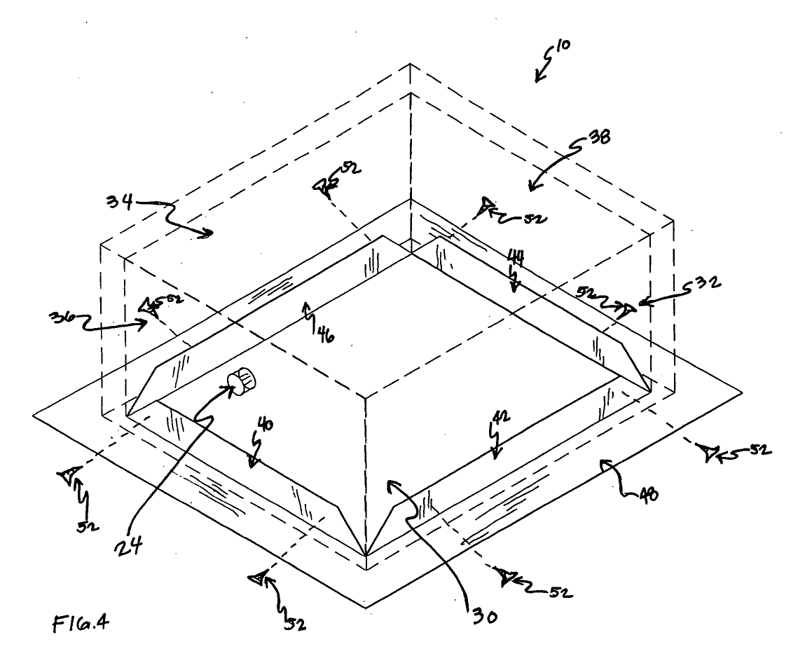

Referring to FIG. 1 in conjunction with FIG. 4, the sheet metal flange 48 is constructed from a blank which is stamped from conventional 22 gauge sheet metal to form depend inward tabs. Enclosure 10 includes a top wall 38 and first through fourth side walls 30, 32, 34, and 36. The first and third side walls 30 and 34 are opposite one another and have a greater lengthwise dimension than the opposed second and fourth side walls 32 and 36. The second and fourth side walls 32 and 36 are designed to accommodate an aperture 24 through the gypsum wallboard to accommodate the passage of conduit 50 and or electrical wiring for the electrical power supply requirements of the light fixture 20 emplaced within the enclosure.

The metal flange is defined on each of the four side walls of enclosure 10 and includes tabs 40, 42, 44, and 46 which depend inwardly from the bottom edges of the first through fourth side walls 30, 32, 34, and 36 respectively. The metal provides support of the drywall enclosure from below and allows for attachment through the flange 48 to the adjacent building joist structure 14. The tabs provide support of light fixture 20 via mechanical fastener 52 to the opposing sides of tabs 40, 42, 44, and 46 respectively.

The exterior of the gypsum wallboard enclosure 10 is wrapped with a continuous tape 11 with an inwardly facing pressure-sensitive adhesive coating which applies pressure to the open joints and forms a corner of continuous gypsum wallboard material when applied.

Referring now to FIG. 5, to install the fire rated fixture enclosure 10 of the subject invention in a first orientation between two ceiling joists spaced at 16.0 inch centers, the flanges adjacent to tabs 40 and 44 are employed. To install the fire rated fixture enclosure in the second orientation between two ceiling joists spaced at 24 inch centers, the flanges adjacent to tabs 42 and 46 are employed as shown in FIG. 5. Conventional screw-type fasteners 54 are utilized to secure the mounting flanges to the lower chords of two spaced apart ceiling joists 14.

A recessed lighting fixture 20 may be emplaced within the enclosure 10 prior to the installation of the enclosure between ceiling joists 14 or afterward. Those skilled in the art will appreciate the flexibility of installing the light fixture either overhead or at the level of a work surface.

Although the subject invention has been described with respect to a preferred embodiment, modifications and changes can be made thereto without departing from the spirit and scope of the invention as defined by the appended claims.

1. A five-sided fire resistant rectangular gypsum wallboard box for use as a recessed ceiling fixture enclosure and formed from a single piece of gypsum wallboard comprising;
a single piece of gypsum wallboard, said wallboard cut to a five wall cross shaped configuration for folding for forming a five-sided structure, including a top wall, said top wall having four side edges around its perimeter, a series of side walls, one of each side wall being integrally connected to the top wall along one of its side edges, said top wall and the four side walls being attached to each other through a living hinge created when the gypsum wallboard has been routed through its front face and the interior fire resistance gypsum core leaving the back paper layer intact to act as said hinge, the edge between the top wall and each side wall being routed internally at a 45° angle so that the side walls can be turned approximately 90° to form an integral enclosure for a recessed lighting fixture, said edges of the top and side walls being routed each at said approximately 45° angle, each of the side walls having side edges, and each of the side edges of said side walls also being routed at a 45°, so that when each side wall is folded relative to the top wall, and the side walls enter into contiguity with the side edge of the adjacent side wall, it forms a mated connection thereat, fire resistant tape means extending along select of the formed edges of the top and side walls to provide sealing between adjacent side walls when formed into a recessed ceiling fixture enclosure, flange means cooperating with those edges of the sidewalls displaced from the top wall to provide means for providing support and mounting of said fixture enclosure to ceiling joists, thereby forming a gypsum wallboard box that retards the spread of fire, flame or hot gases through the ceiling opening in which the wall board box and any light fixture may locate.

2. The recessed ceiling fixture enclosure of claim 1 including a lighting fixture cooperating with and mounting to the flange means when mounting the ceiling fixture within the ceiling fixture enclosure.

3. The method of fabricating a fire resistant five-sided rectangular gypsum wallboard box from a single piece of gypsum wallboard having front and back faces and a core intermediate therebetween and for application to a ceiling penetration, comprising the steps of;
a. machine router cutting a 45 degree inside groove by cutting through the front paper face of the gypsum wallboard and through the gypsum wallboard core to a point adjacent to the back face to form a living hinge, and folding the cut wallboard for forming a top and plurality of sidewalls having exterior and interior wall surfaces;
b. folding said wallboard to form a box and fastening said formed box edges to each other via a mechanical fastener;
c. mounting said wallboard box to a continuous sheet metal flange via a mechanical fastener;
d. wrapping the exterior of said enclosure at the edge grooves of the open joints with a continuous tape and with an inwardly facing pressure-sensitive adhesive coating which applies pressure to the open joints and forms an edge of continuous gypsum wallboard material;
e. mounting said enclosure and flange between spaced apart building joists adjacent said ceiling penetration, such that said enclosure defines a fire stop system prior to installation, and once installed, limits the spread of fire, flame or hot gases through said ceiling penetration;
f. emplacing a recessed fixture within said wallboard enclosure;
g. passing electrical conduit and electrical wiring through an aperture formed on at least one side wall of the enclosure; and
h. performing the step of sealing the aperture with a fire resistant material around the electrical conduit.

4. A method for installing a recessed fixture within said formed wallboard box according to claim 3, wherein the step of mounting said enclosure between spaced apart building joists comprises positioning said housing between joists spaced at 16.0 inch centers.

5. A method for installing a recessed fixture within said formed wallboard box according to claim 3 wherein the step of mounting said enclosure between a pair of wood joist spaced at 24.0 inch centers.
